(19) United States
(12) Patent Application Publication
(10) Pub. No.: US 2007/0029100 A1
(43) Pub. Date: Feb. 8, 2007

(54) Disc bearing attachment for chisel plow

(76) Inventor: Ronald R. Tschetter, Carpenter, SD (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/497,873

(22) Filed: Aug. 2, 2006

Related U.S. Application Data
(60) Provisional application No. 60/706,468, filed on Aug. 8, 2005.

(51) Int. Cl. A01B 59/00

(52) U.S. Cl. 172/680

(57) ABSTRACT

A method and apparatus are provided for converting a chisel plow to a disc plow using a disc bearing assembly for attachment to the chisel shank of the chisel plow.

### CROSS-REFERENCE TO RELATED APPLICATION

The present application is based on and claims the benefit of U.S. provisional patent application Ser. No. 60/706,468, filed Aug. 8, 2005, the content of which is hereby incorporated by reference in its entirety.

### FIELD OF THE DISCLOSURE

The present disclosure relates generally to earth working and agricultural implements, and more particularly but not by limitation to an opener attachment for a chisel plow.

### BACKGROUND

Traditional farming methods typically include regular tilling that agitates the soil in various ways with tractor-drawn implements. For example, some farmers use a chisel plow to loosen and aerate the soil. A chisel plow typically includes an elongated chisel supported by a c-shaped shank that is spring-mounted to the frame of the implement.

Regular tilling, however, can lead to unfavorable effects, such as increased soil erosion due to wind or rainwater and decreased soil moisture due to increased evaporation. Therefore, most farmers have been moving toward a low-till or no-till system with which the soil is left largely undisturbed from harvest to planting. Planting or drilling is accomplished in a narrow slot created by an opener, such as a coulter, row cleaner, disc, in-row chisel or rotor-tiller.

A low-till system can be performed with as little as one pass over the soil for planting, depending on the implement used, compared to two or more tilling operations plus planting for conventional tilling. This results in less time expended in the field and reduces machinery wear and costs. Fewer passes over the soil also save on fuel expenses. With a low-till system, crop residue left on the soil surface reduces water evaporation and erosion and corresponding air pollution.

One method of low-till planting includes the use of a disc plow having one or more rows of circular discs that penetrate the residue and soil surface to open slots or furrows for seed placement. A modern disc plow typically includes several other implements mounted on the same frame such as gauge wheels for setting the opening depth, furrow points to define the seed trenches, planters to place seed in the furrows, covering discs to fill the furrows and press wheels to compress the soil over the furrows. These implements typically have many rows for processing a large number of furrows at one time. The disc plow portion of the implement typically has a large number of discs that are mounted on a single, common shaft and separated from one another by one or more collars.

A farmer wanting to convert from conventional tilling methods to a low-till system must therefore replace the chisel plow with a new implement, which would require a significant investment in the new machinery. The chisel plow would then remain unused. Many farmers either cannot afford or do not wish to make large investments in such new equipment. As a result, many farmers continue unfavorable tilling or make large, unwanted capital investments in new equipment.

The present disclosure provides a solution to this and other problems and offers other advantages over the prior art.

### SUMMARY

A method and apparatus are provided for converting a chisel plow to a disc plow using a disc bearing assembly for attachment to the chisel shank of the chisel plow.

One embodiment of the present invention is directed to a farm implement comprising a frame, a chisel shank, a hub assembly attached to the chisel shank and at least one soil opener rotatably supported by the hub assembly.

Another embodiment is directed to an opener bearing attachment for a chisel plow. The attachment includes a mount having mounting features that mate with a chisel shank of the chisel plow and a hub assembly attached to the mount and adapted to rotatably support a soil opener.

Another embodiment is directed to a kit for converting a chisel plow into a disc plow. The kit includes a mount having mounting features that mate with a chisel shank of the chisel plow. A hub assembly is attached to the mount and is adapted to rotatably support a disk opener.

Another embodiment is directed to a method of converting a chisel plow to a disc plow. The method includes: detaching a chisel from a chisel shank that is carried by the chisel plow; attaching a disk bearing assembly to the chisel shank; and attaching a disk opener to the disc bearing assembly.

Other features and benefits that characterize embodiments of the present disclosure will be apparent upon reading the following detailed description and review of the associated drawings.

### BRIEF DESCRIPTION OF THE DRAWINGS

FIG. 1 is a perspective view of a chisel plow that has been converted to carry a plurality of openers, according to one embodiment of the present invention.

FIG. 2A is a perspective view of a traditional chisel mounted to one of the chisel shanks of the chisel plow shown in FIG. 1.

FIG. 2B is a perspective view of the chisel shank having the chisel detached.

FIG. 2C is a perspective view of a disc bearing assembly mounted to the chisel shank according to one embodiment of the present invention.

FIG. 3 is an exploded, schematic view of a hub assembly portion of the disc bearing assembly shown in FIG. 2.

FIG. 4 is a cross-sectional view of the hub assembly in an assembled state.

FIG. 5 is a plan view of one of a hub plate of the hub assembly.

FIG. 6A is a side plan view of a hub spacer of the hub assembly.

FIG. 6B is an end view of the hub spacer.

FIG. 7 is a side plan view of a bearing dust cover of the hub assembly.

FIG. 8 is a side plan view of a spacer washer of the hub assembly.

FIG. 9A is a side view of a bearing center support of the hub assembly.

FIG. 9B is an end view of the bearing center support.

FIG. 10 is a side plan view of a shaft of the hub assembly.

FIG. 11A is a plan view of a mounted bracket of the hub assembly prior to forming.

FIG. 11B is an end view of the mounting bracket after forming.

FIG. 11C is a perspective view of the mounting bracket after forming.

FIG. 12A is a cross-sectional view of a disk according to an alternative embodiment of the present invention.

FIG. 12B is an enlarged view of an edge detail area of the disk shown in FIG. 12A.

FIG. 12C is a fragmentary, perspective view of a notch in the disk blade shown in FIG. 12A.

FIG. 12D is an enlarged cross sectional view the notch shown in FIG. 12C.

### DETAILED DESCRIPTION OF ILLUSTRATIVE EMBODIMENTS

An embodiment of the present invention relates to a disc bearing attachment for a chisel plow, which allows one or more discs to be mounted to the chisel shank of a traditional chisel plow. A chisel plow can be converted to a low-till or no-till disc plow simply by removing the chisel from the chisel shank and mounting the disc bearing assembly to the chisel shank. Since most farmers already own a chisel plow, these farmers can convert to low-till methods with minimal investment in new equipment.

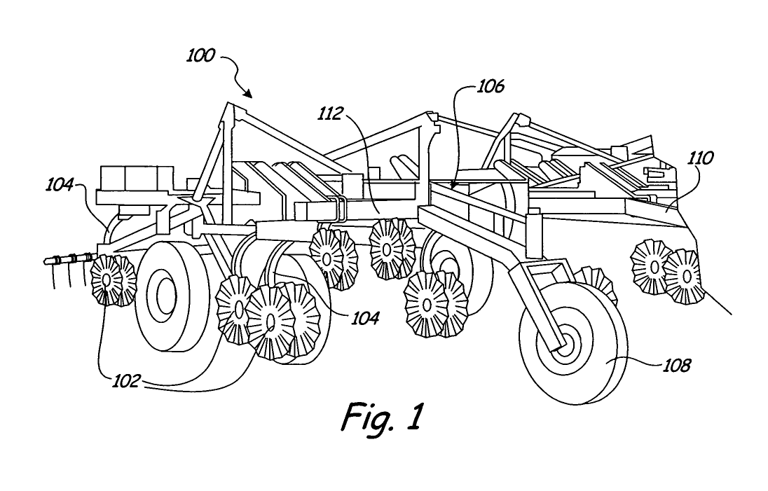

FIG. 1 is a perspective, fragmentary view of a chisel plow 100 that has been converted to carry a plurality of openers, such as discs 102 on the existing c-shaped chisel shanks 104 of the plow 100. Chisel shanks 104 are spring-mounted in a known manner to frame 106 of plow 100. Frame 106 is supported by a plurality of wheels 108 and has a tow bar 110 for attachment to a tractor (not shown). Frame 106 has one or more beams 112 onto which one or more of the chisel shanks 104 are mounted. Frame 106 can have any arrangement and number of beams 112, and each beam 112 can support any number or arrangement of chisel shanks 104.

In the embodiment shown in FIG. 1, shanks 104 are chisel plow shanks having a typical c-shape for supporting a chisel in a spring-loaded relationship with respect to frame 106. However, frame 106 can support any other type and shape of shank 104. In this embodiment, each shank 104 is formed of a rectangular steel bar onto which the chisels would normally be mounted. However, the chisels have been removed from each chisel shank 104 and replaced with a respective disc bearing assembly 102 in accordance with one embodiment of the present invention. The chisel shanks can have any elongated shape and any cross section, such as tubular or solid cross section.

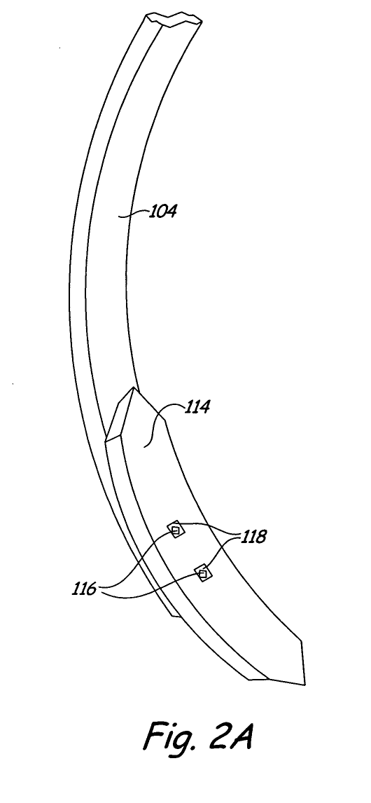

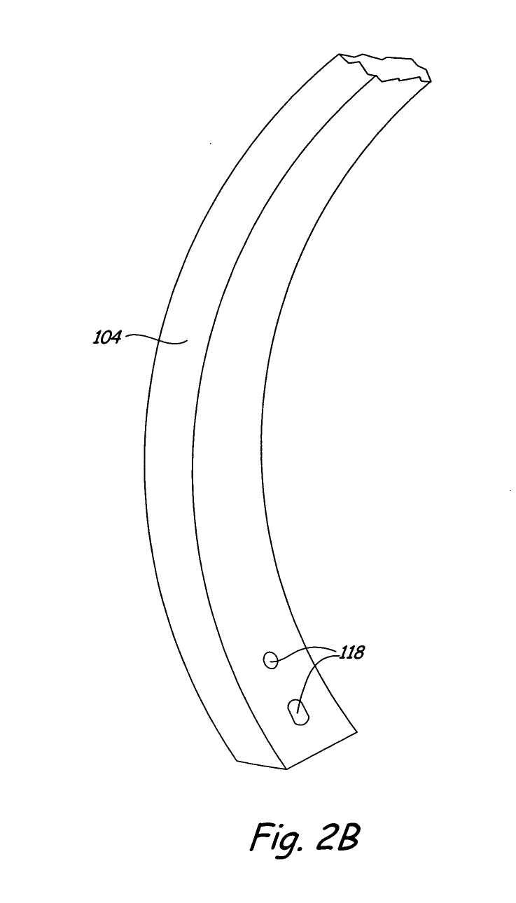

FIGS. 2A-2C illustrate a method of converting the chisel plow shown in FIG. 1 to a disc plow according to one embodiment of the present invention. FIG. 2A is a perspective view of a traditional chisel 114 mounted to one of the chisel shanks 104 of the chisel plow 100 shown in FIG. 1. In this embodiment, chisel 114 is mounted to chisel shank 104 with one or more bolts 116, which extend through one or more apertures or bores 118 in chisel 114 and chisel shank 104. Depending on the construction of shank 104, chisel 114 can be mounted to the exterior of the shank as shown in FIG. 2A or inserted into a tube formed by shank 104 in alternative embodiments. In one embodiment, shank 104 has a solid cross-section having dimensions of 1 1/2 inches by 2 inches.

In order to convert chisel plow 100 into a disc plow, chisel 114 is detached from chisel shank 104 by removing bolts 116 from apertures 118 and removing the chisel from the shank, as shown in FIG. 2B. A disc bearing assembly can then be mounted to chisel shank 104 using the same mounting apertures 118 in accordance with one embodiment of the present invention. However other mounting apertures can be used in alternative embodiments.

FIG. 2C is a perspective view, which illustrates a disc bearing assembly 102 attached to chisel shank 104 according to the embodiment shown in FIG. 1. Disc bearing assembly 100 is bolted to chisel plow shank 104 with bolts 116. As mentioned above, the same mounting apertures 118 (shown in FIG. 2B) are used to mount disc bearing assembly 102 to chisel shank 104. However, disc bearing assembly 100 can be attached to chisel shank 104 through other apertures or other methods of attachment, such as by welding.

Disc bearing assembly 102 includes hub assembly 120 and a pair of disc type openers 122. Discs 122 are attached to a hub plate of hub assembly 120 through a plurality of bolts 124. The hub plate is attached to a spindle shaft of hub assembly 120 through a bolt 126. Hub assembly 120 serves to mount disc bearing assembly 102 to chisel shank 104 while allowing discs 122 to rotate as the plow pulls the discs along the soil. Discs 122 can have any desired size, shape or orientation in alternative embodiments of the present invention. In addition, other types of openers can be attached to hub assembly 120 in place of discs 122.

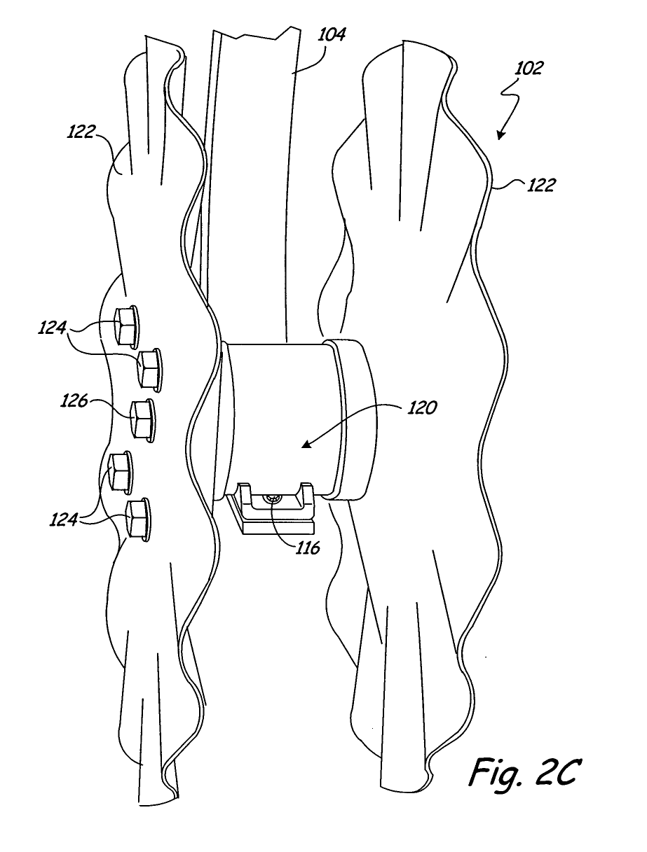

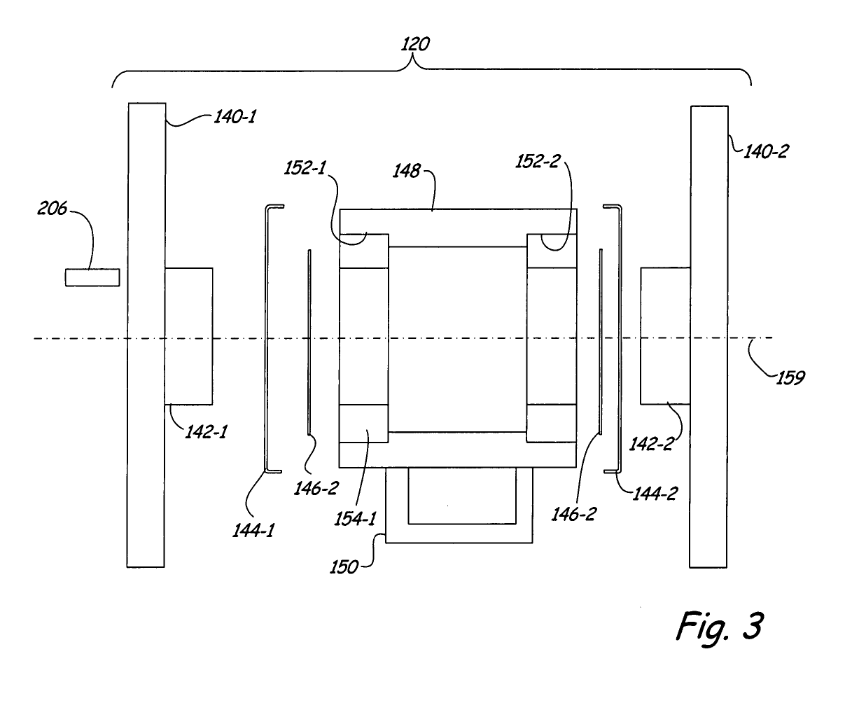

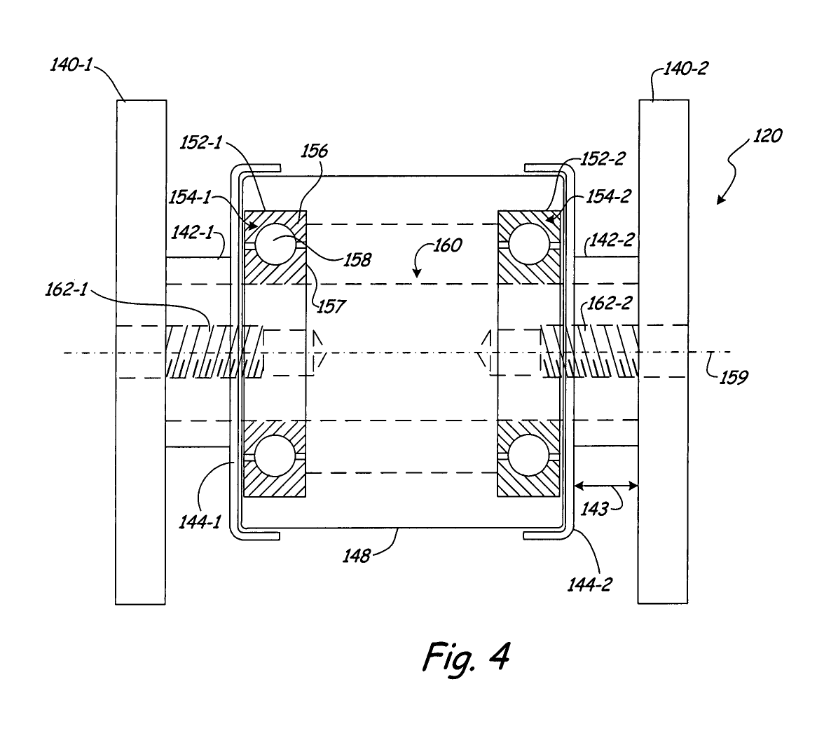

FIG. 3 is an exploded, schematic, cross-sectional view of hub assembly 120. The dimensions of each part of hub assembly 120 are provided below. However, each part can have any other suitable dimension in alternative embodiments of the present invention. These dimensions are provided as examples only and are not intended to be limiting. FIG. 4 is a cross-sectional view of hub assembly 120 in an assembled state.

Referring to FIGS. 3 and 4, hub assembly 120 includes a pair of opposing hub plates 140-1 and 140-2, a pair of hub spacers 142-1 and 142-2, a pair of bearing dust covers 144-1 and 144-2, a pair of spacer washers 146-1 and 146-2, a bearing center support 148, a mounting bracket 150, and a pair of bearings 154-1 and 154-2. Hub plates 140-1 and 140-2 attach to discs 122 through the bolts 124 shown in FIG. 2. Hub spacers 142-1 and 142-2 provide clearance so that hub plates 140-1 and 140-2 together with their attached discs 122 can rotate freely about the central axis of bearing center support 148 without contacting the outside surfaces of dust covers 144-1 and 144-2 or chisel shank 104 (shown in FIG. 2). As shown in FIG. 4, hub spacers 142-1 and 142-2 provide a clearance of 0.9195 inches, for example, as shown by arrow 143.

Bearing dust covers 144-1 and 144-2 provide a seal for isolating the bearings housed within center support 148 from dust and other debris during operation. Spacer washers 146-1 and 146-2 provide clearance to allow the shaft and dust covers 144-1 and 144-2 to rotate without interfering with the stationary portions of the bearing assemblies or bearing center support 148. In one embodiment, spacer washers 146-1 and 146-2 provide about a 0.040 inch clearance between the inner surface of the dust covers and the stationary portions of the bearing assemblies or bearing center support 148.

In one embodiment, bearing center support 148 is formed of a 3 inch length of pipe having a 3 inch outer diameter and a 2.5 inch inner diameter, for example. Notches 152-1 and 152-2 are machined into the inner diameter surface at each of the pipe to form seats (having an inner diameter between opposing notches of about 2.8346 inches, for example) for receiving a pair of ball bearing assemblies 154-1 and 154-2 (shown in FIG. 4). Ball bearing assemblies 154-1 and 154-2 can be mounted into bearing seats 152-1 and 152-2 by a friction-fit, for example. However, any other type of attachment method can be used in alternative embodiments of the present invention. Bearing assemblies 154-1 and 154-2 each include an outer race 156 supported by bearing seat 152, an inner race 157 and a plurality of ball bearings 158 between the inner and outer races. Other types of bearings can also be used, such as thrust and radial bushings, for example.

The inner races 157 of ball bearing assemblies 152-1 and 152-2 support a shaft 160 (shown in FIG. 4) along central axis 159. Shaft 160 has a pair of threaded bores 162-1 and 162-2, one at each end of the shaft, for receiving bolts 126 (shown in FIG. 2C) that mount hub plates 140-1 and 140-2 to shaft 160.

Mounting bracket 150 (shown in FIG. 3) is attached to the outer diameter of bearing center support 148 by any suitable method, such as by welding. Mounting bracket 150 is then, in turn, mounted to chisel shank 104 as shown in FIG. 2C.

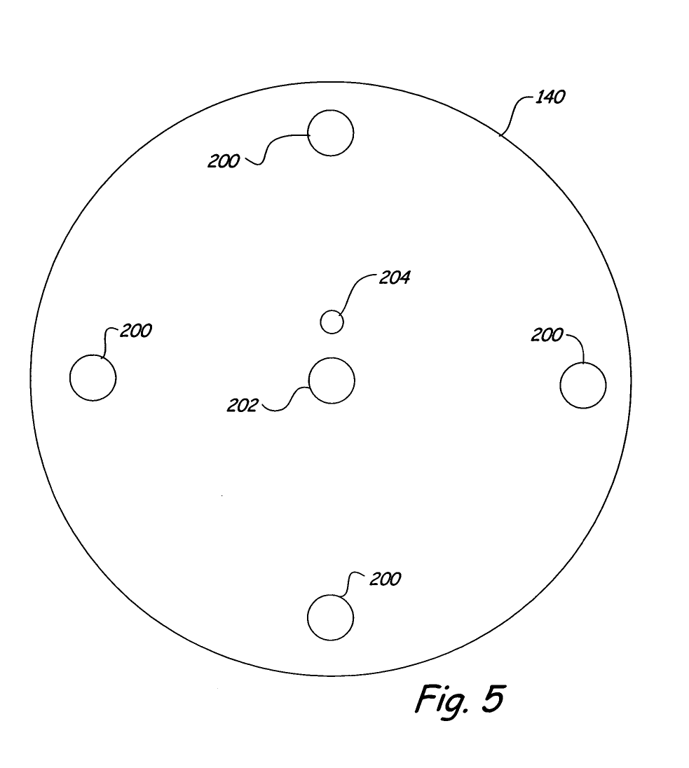

FIGS. 5-11 illustrate the various elements of hub assembly 120 in greater detail, according to an example embodiment of the present invention. FIG. 5 is a plan view of one of the hub plates 140. In this example, hub plate 140 is a disc formed of a suitable material, such as steel or aluminum, having a thickness of 0.375 inches and an outer diameter 6.25 inches, for example. Hub plate 140 includes a plurality of bores or holes 200, which mate with corresponding holes in disc 122 (shown in FIG. 2) and receive the bolts 124 (also shown in FIG. 2) for mounting disc 122 to hub plate 140. Holes 200 are aligned along a 5-inch diameter circle relative to a center bore or hole 202. Each hole 200 has a diameter of about 0.53125 inches, for example.

Center bore or hole 202 receives bolt 126 (shown in FIG. 2) for mounting hub plate 140 to one end of the shaft 160 (shown in FIG. 4). Bolt 126 is received within threaded bore 162 of shaft 160. Center hole 202 has a diameter of 0.7812 inches, for example. A further, hole or bore 204 is offset from the center of hub plate 140 for receiving a roll pin 206 (shown in FIG. 3) or bolt, which can extend into a similar bore in shaft 160 to prevent relative rotation between the disk plate and shaft 160. Hole 204 can have a diameter of 0.2460 inches, for example. In one example, the roll pin 206 is a 0.25 inch by 1.00 inch steel roll pin. Hub plate 140 can have any suitable set of dimensions, shapes and hole patterns in alternative embodiments of the present invention. Also, a particular type of opener or disc may have its own hub plate, which can mount directly to shaft 160 in alternative embodiments. In these embodiments, hub plate 140 would not be used.

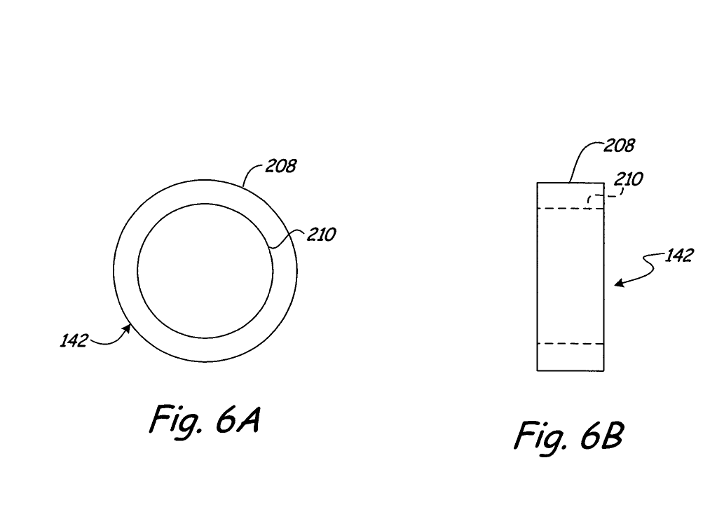

FIG. 6A is a side plan view of one of the hub spacers 142. FIG. 6B is an end view of hub spacer 142. In one embodiment and hub spacer 142 is formed of a 0.913-0.917 inch length of pipe section having an outer diameter 208 with a dimension of 1.875 inches and an inner diameter 210 with a dimension of 1.38-1.39 inches. However, any other dimension or size can be used in alternative embodiments of the present invention. Also, hub spacers 140 may be eliminated in this embodiment or in alternative embodiments of the present invention.

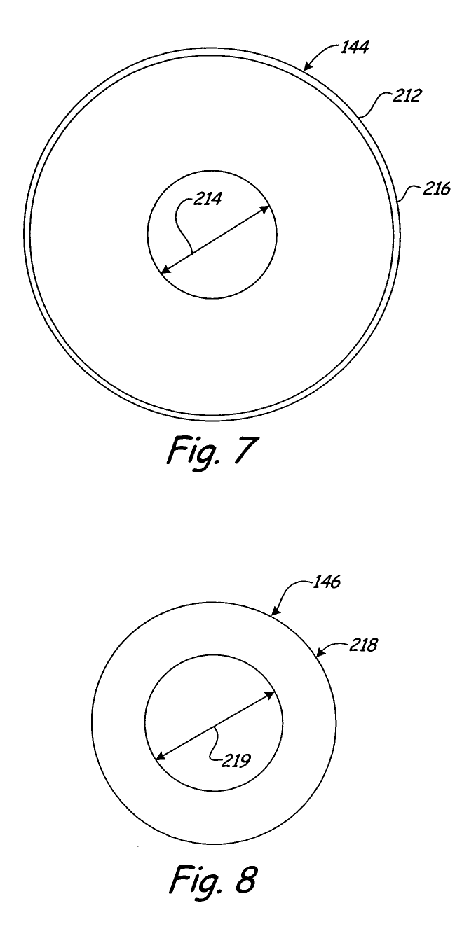

FIG. 7 is a side plan view of bearing dust cover 144. In one embodiment, dust cover 144 is formed of 14-gauge steel having a 4.378 inch outer diameter 212, a 1.386 inch center bore or hole 214 and an edge 216 that is bent upwards approximately 90 degrees relative to the major surface of dust cover 144 to form a cup shape. In one embodiment, edge 216 has a height of about 0.500 inches.

FIG. 8 is a side plan view of one of the spacer washers 146. In one embodiment, spacer washer 146 is formed of 18-gauge steel and has a 2.44-2.47 inch outer diameter 218 and a 1.369-1.375 inch inner diameter 219, for example.

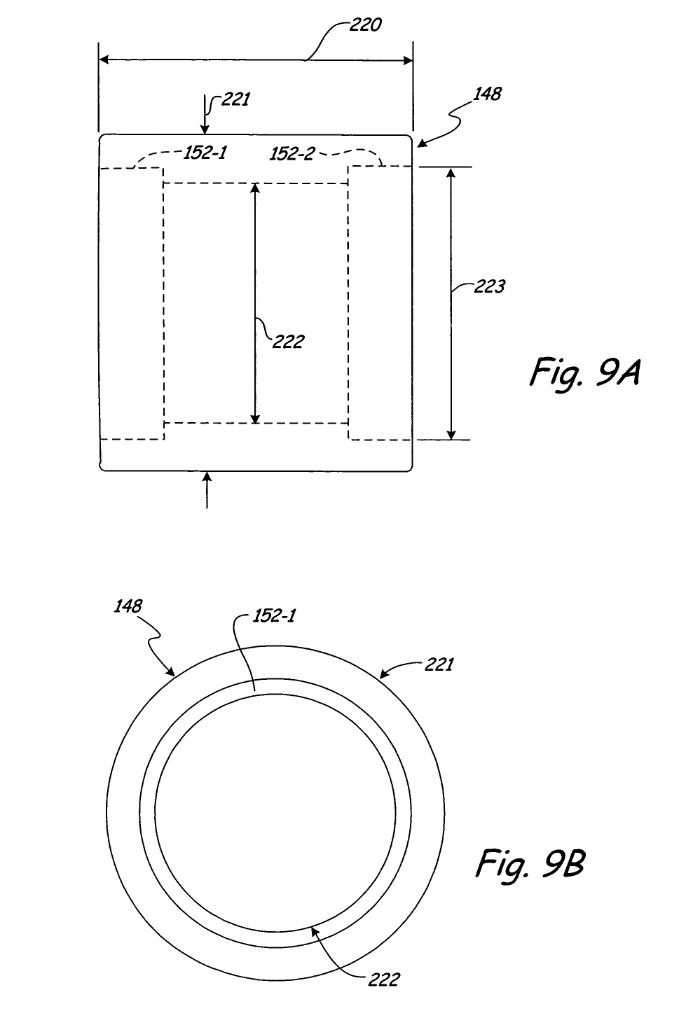

FIG. 9A is a side view of bearing center support 148, and FIG. 9B is an end view of bearing center support 148. In one embodiment, bearing center support 148 is formed of a pipe section having a length 220 of 3 inches, and outer diameter 221 of 3 inches and an inner diameter 222 of 2.5 inches. Machined bearing seats 152-1 and 152-2 have an inner diameter 223 of about 2.8346-2.8353 inches and a depth of about 0.664-0.668 inches, for example.

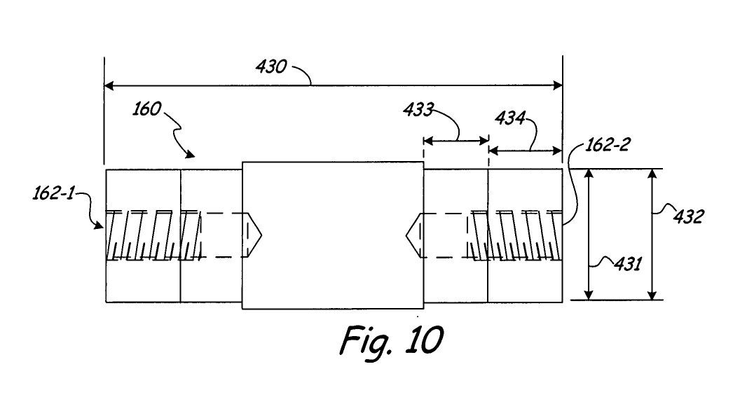

FIG. 10 is a side plan view of shaft 160 according to one embodiment of the present invention. In this example, shaft 160 has a length 430 of 5.063 inches, an outer diameter 431 along length 434 of approximately 1.373 (+/−0.0005) inches, and an outer diameter 432 along length 433 of approximately 1.378 (+/−0.0005) inches for mating with the inner race 157 of bearing assemblies 154 (shown in FIG. 4) and the inner diameter of hub spacers 142 (also shown in FIG. 4). Shaft 160 further includes 11/16 (0.6875) inch threaded bores 162-1 and 162-2 having depths of about 1.5 inches for receiving bolts 126 (shown in FIG. 2), which mount hub plates 140 (FIG. 5) to shaft 160.

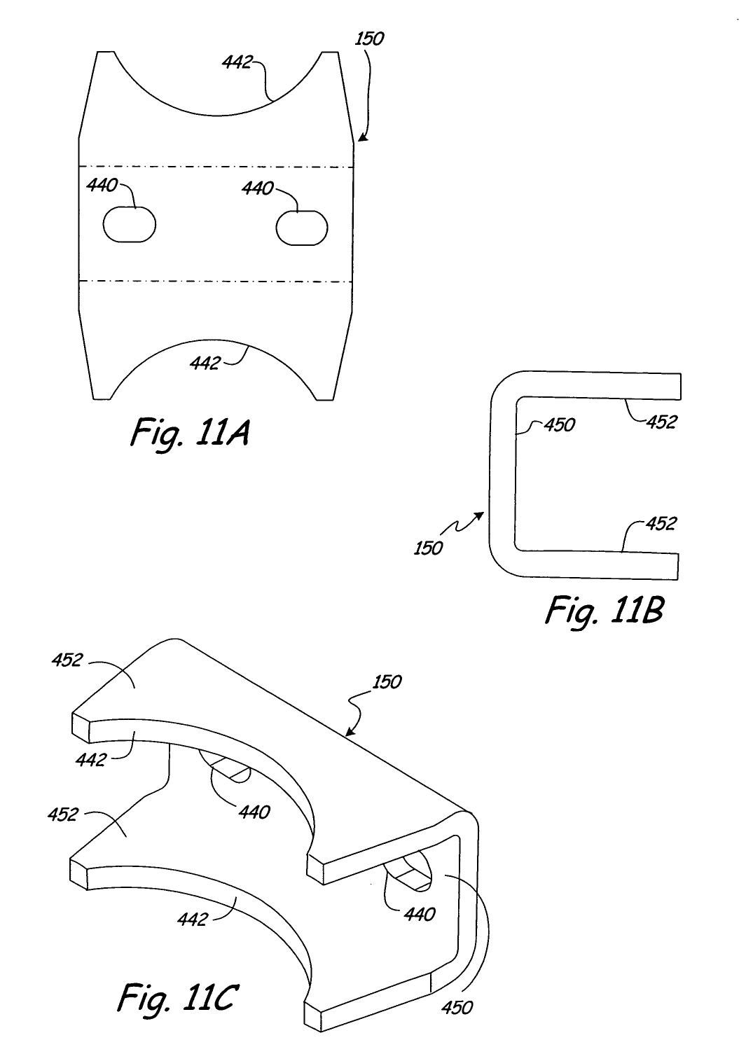

FIG. 11A is a plan view of mounting bracket or saddle 150 prior to forming. Mounting bracket 150 has a pair of holes (also known as bores or apertures) 440 for receiving bolts with which the mounting bracket can be attached to chisel shank 104 (shown in FIG. 2B). Mounting bracket 150 can have any numbers, size and pattern of holes 440 in alternative embodiments of the present invention. In one embodiment, holes 440 are positioned so that they mate with corresponding holes 118 in the chisel shank that were used to mount the chisel being replaced by the disc bearing assembly.

Mounting bracket 150 further includes a pair of curved edges 442 having a radius of curvature (such as 1.75 inches) that substantially matches the outer diameter surface of the bearing center support 148 shown in FIGS. 3, 4 and 9.

FIG. 11B is an end view of mounting bracket 150 after forming by a press, for example. After forming, mounting bracket 150 has a base plate 450 and a pair of arms 452 that have a length of 1.85 inches, for example.

FIG. 11C is a perspective view of mounting bracket 150. After forming, the curved edges 442 of arms 452 define a saddle for receiving the bearing center support 148. The bracket can have a thickness of 1/4 inches, a length of 2 inches and a width of 1.91 inches, for example. Curved edges 442 are welded to the outer diameter surface of bearing center support 148, for example. However, other methods of mounting the bracket to the bearing center support can be used in alternative embodiments of the present invention.

Once assembled, the entire hub assembly 120 can be mounted to chisel shank 104 through the holes 440 in mounting bracket 150. As mentioned above, if holes 440 match the existing holes in chisel shank 104, it is a simple process to disconnect the original chisel 114 from shank 104 and replace the chisel 114 with hub assembly 120, as shown in FIGS. 2A-2C. Other types of mounting brackets or methods of mounting hub assembly 120 to chisel shank 104 can be used in alternative embodiments of the present invention.

The disc bearing assembly illustrated above can therefore be used to replace traditional chisels on a chisel plow in order to convert the chisel plow into a no-till or reduced-till disc plow without requiring the farmer to make large investments in new capital equipment. Since most farmers already own a chisel plow, these plows can easily be converted and reused with minimal investment.

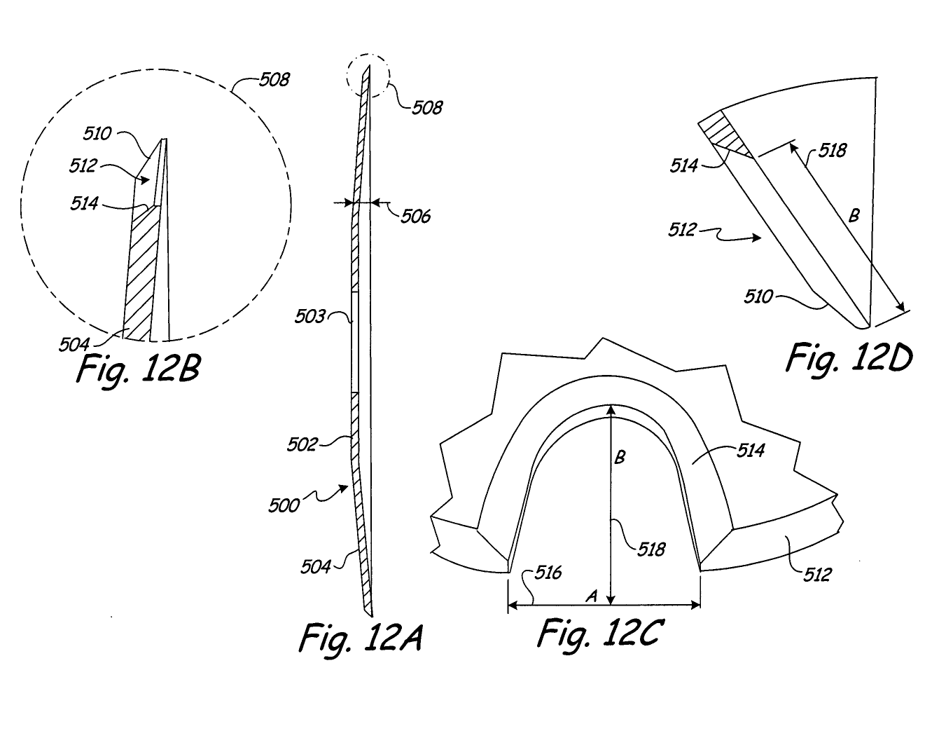

FIGS. 12A-12D illustrate a disk 500 according to an alternative embodiment of the present invention. FIG. 12A is a cross-sectional view of disk 500. Disk 500 includes a generally planar hub attachment portion 502 and an angled peripheral blade portion 504. Hub portion 502 includes a central aperture 503 for attachment to hub plate 140 (shown in FIG. 5). In this embodiment, blade portion 504 is angled, or coned, relative to hub attachment portion by an angle 506 of approximately 5 degrees, for example. A small angle serves to throw a very small amount of soil during operation while still maintaining a reduced-till system. However, other cone angles can also be used, such as angles less than or approximately equal to 30 degrees.

Disk 500 has an overall diameter of about 510 (+/−2) millimeters, while planar hub attachment portion 502 has a diameter of about 170 (+/−3) millimeters. Disk 500 has a thickness of 5 (+/−0.25) millimeters, for example.

FIG. 12B is an enlarged view of an edge detail area 508 of disk 500 shown in FIG. 12A. The peripheral edge 510 of blade portion 504 is beveled or sharpened at an angle of about 30 degrees +/−5 degrees, for example. The tip of each bevel has a thickness of about 0.8 (+/−0.4) millimeters, for example. In addition, blade portion 504 includes a set of notches 512 cut into the peripheral edge 510 to assist in cutting through residue on the soil surface, such as corn stock. In one embodiment, blade portion 504 includes nine notches evenly distributed about the circumference of blade portion 504. However, any other number of notches can be used. Each notch 510 has a generally U-shape, as shown in FIG. 12C, although any shape can be used in alternative embodiments. The inside edge 514 of each notch 512 is beveled at an angle of approximately 50 degrees +/−5 degrees, for example. However, any other angle of edge bevel can be used in alternative embodiments. FIG. 12C is a fragmentary, perspective view of one of the notches 512. In this embodiment, each notch 512 has a length 516 of approximately 3.15 inches and a depth 518 of approximately 2.36 inches. FIG. 12D is an enlarged cross sectional view the notch 512 shown in FIGS. 12B and 12C.

At least one embodiment of the invention is directed to a kit for converting a chisel plow into a disc plow. The kit includes an opener bearing attachment having a mount comprising mounting features that mate with a chisel shank of the chisel plow. A hub assembly is attached to the mount and is adapted to rotatably support a soil opener, such as a disk. For example, the mounting features can include a pattern of mounting apertures that mate with corresponding mounting features in the chisel shank. These mounting features can also be arranged in patterns that mate with a variety of different chisel shanks or shanks for other types of implements. The hub assembly can also include a hub plate having mounting apertures arranged in a pattern to mate with corresponding mounting apertures in the disk opener. The kit can further include the disk opener, which can be supplied attached or detached from the hub plate. The hub assembly can include any of the features discussed above with respect to FIGS. 1-12.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the plow while maintaining substantially the same functionality without departing from the scope and spirit of the present invention. In addition, it will be appreciated by those skilled in the art that the teachings of the present invention can be applied to any plow or agricultural implement in which soil openers, such as discs, are useful without departing from the scope and spirit of the present invention. The bearing assembly can be attached to any type of shank, whether the shank is a chisel shank or a different type of shank, for replacing any type of earth working attachment with any type of opener.

What is claimed is:

1. A farm implement comprising a frame, a chisel shank, a hub assembly attached to the chisel shank and at least one soil opener rotatably supported by the hub assembly.

2. The farm implement of claim 1 wherein the mount comprises mounting features that mate with the chisel shank.

3. The farm implement of claim 2 wherein the mounting features comprise a plurality of mounting apertures that mate with corresponding mounting apertures in the chisel shank.

4. The farm implement of claim 1 and further comprising a hub plate to which the soil opener is attached, wherein the hub plate is rotatably supported by the hub assembly.

5. The farm implement of claim 1 wherein the soil opener comprises a disk.

6. The farm implement of claim 5 wherein the disk comprises a plurality of notches arranged along a circumference of the disc, the notches comprising a beveled edge.

7. The farm implement of claim 1 wherein the hub assembly comprises the following coaxial elements:
a hub;
a spindle shaft rotatably supported by the hub through at least one bearing;
a hub plate attached to the spindle shaft and rotatable with the spindle shaft;
a dust cover positioned between the hub plate and end of the hub, which at least partially seals an internal cavity of the hub;
a hub spacer, which spaces an inner surface of the hub plate from the dust cover; and
a spacer washer, which provides a clearance between the hub and the dust cover.

8. The opener bearing attachment of claim 1 wherein the mount comprises a base portion and first and second arms that are bent out-of-plane with respect to the base portion and form a saddle for attachment to the hub assembly, wherein the base portion comprises mounting features that mate with corresponding mounting features of the chisel shank.

9. An opener bearing attachment for a chisel plow, the attachment comprising:
a mount comprising mounting features that mate with a chisel shank of the chisel plow; and
a hub assembly attached to the mount and adapted to rotatably support a soil opener.

10. The opener bearing attachment of claim 9 wherein the mount comprises a mounting bracket comprising a plurality of apertures that mate with corresponding apertures in the chisel shank.

11. The opener bearing attachment of claim 9 and further comprising a soil opener and a hub plate having mounting apertures arranged in a pattern to mate with corresponding mounting apertures in the soil opener.

12. The opener bearing attachment of claim 9 wherein the soil opener comprises a disk.

13. The opener bearing attachment of claim 12 wherein the disk comprises a plurality of notches arranged along a circumference of the disc, the notches comprising a beveled edge.

14. The opener bearing attachment of claim 9 wherein the hub assembly comprises the following coaxial elements:
a hub;
a spindle shaft rotatably supported by the hub through at least one bearing;
a hub plate attached to the spindle shaft and rotatable with the spindle shaft;
a dust cover positioned between the hub plate and end of the hub, which at least partially seals an internal cavity of the hub;
a hub spacer, which spaces an inner surface of the hub plate from the dust cover; and
a spacer washer, which provides a clearance between the hub and the dust cover.

15. The opener bearing attachment of claim 9 wherein the mount comprises a base portion and first and second arms that are bent out-of-plane with respect to the base portion and form a saddle for attachment to the hub assembly, wherein the mounting features are located on the base portion.

16. A kit for converting a chisel plow into a disc plow, the kit comprising:
a mount comprising mounting features that mate with a chisel shank of the chisel plow; and
a hub assembly attached to the mount and adapted to rotatably support a disk opener.

17. A method of converting a chisel plow to a disc plow, comprising:
detaching a chisel from a chisel shank that is carried by the chisel plow;
attaching a disk bearing assembly to the chisel shank; and
attaching a disk opener to the disc bearing assembly.

18. The method of claim 16 wherein:
detaching a chisel comprises removing bolts that attach the chisel to the chisel shank; and
attaching a disk bearing assembly comprises bolting a mounting bracket to the chisel shank, wherein the mounting bracket comprises mounting apertures that mate with corresponding mounting apertures in the chisel shank, and wherein the mounting bracket is attached to the disk bearing assembly.
